(19) United States
(12) Patent Application Publication
(10) Pub. No.: US 2005/0198425 A1
(43) Pub. Date: Sep. 8, 2005

(54) COMBINED OPTICAL STORAGE AND FLASH CARD READER USING SINGLE IDE OR SATA PORT AND METHOD THEREOF

(76) Inventor: Liang-Yun WANG, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,464

(22) Filed: Mar. 5, 2004

(51) Int. Cl. G06F 13/00

(52) U.S. Cl. 710/305; 710/100

(57) ABSTRACT

An electronic system includes a host; a controller electrically coupled to the host through a single port of a predetermined bus, the single port for providing the host access to N devices; and M peripheral devices electrically coupled to the controller, M being greater than N.By modifying control codes, reserved vendor-specific bits in packets or registers in an IDE task file that are sent between the host and the controller, the host is able to specify a target peripheral device and to determine which peripheral device sent each packet that is received by the host. In this way, the host can access the peripheral devices using the single port. When the peripheral devices include a first peripheral device and a second peripheral device, the controller can directly transfer data stored on the first peripheral to the second peripheral device without requiring the data to be buffered in the host.

### BACKGROUND OF INVENTION

1. Field of the Invention

The invention relates to an electronic system, and more particularly, to an information storage and retrieval system having a combined optical storage device and flash card reader using a single port of an Integrated Drive Electronics (IDE) bus or a Serial AT Attachment (SATA) interface.

2. Description of the Prior Art

In today's information oriented society, electronic information accessing devices are increasingly playing a crucial role both in business applications and in the home. In particular, personal computers (PCs), optical storage media, and flash card devices are now well accepted and important technologies. In order to combine the functions and advantages of these three technologies, interconnect buses such as the Integrated Drive Electronics (IDE) bus, also known as the AT Attachment (ATA) bus or the Parallel AT Attachment (PATA) bus, as well as the Serial AT Attachment (SATA) interface are now in wide use.

FIG. 1 is a diagram of a typical IDE bus cable 100. Because it is often desirable to access a plurality of peripheral devices from a host, the IDE bus cable 100 transfers data bits in parallel between the host and up to two peripheral devices. The IDE bus protocol specifies the concept of channels and ports. Each channel in an IDE bus includes a first port and a second port and is normally associated with a single physical cable. For example, the IDE bus cable 100 shown in FIG. 1 is an IDE bus channel and includes Port 0 and Port 1, which can be connected to a first peripheral device and a second peripheral device, respectively. When two devices are respectively connected to the two ports of an IDE channel, one of the devices acts as a master and one of the devices acts as a slave. This configuration allows the two devices to share the IDE bus cable 100. Please note that each cable in a SATA interface only connects to a single device, and the SATA interface transfers information serially instead of in parallel.

FIG. 2 is a block diagram of a first IDE/SATA architecture 200 having a single peripheral device 204 according to the prior art. The first IDE/SATA architecture 200 includes the peripheral device 204 electrically connected to a host 202 using an IDE or SATA channel 206. The host 202 could be a personal computer system, a central processing unit (CPU) of an embedded system, or another device that needs to access the peripheral device 204. In the first IDE/SATA architecture 200 shown in FIG. 2, the peripheral device 204 is an optical storage device and includes a controller 208, buffer memory 214, an optical storage medium 212, and an optical pick-up 210. The optical pick-up 210 has a plurality of sensors that follow a track on the optical storage medium 212. According to signals received by the sensors, which detect reflected light from a laser that reflects off pits on the optical storage medium 212, a received signal is obtained. Afterwards the received signal undergoes a decoding process to be converted into received bits. For writing to the optical storage medium 212, a reverse operation is performed with the laser burning the pits into the optical storage medium 212 corresponding to a transmit signal encoded according to a set of transmitted bits. As the detailed operation of optical storage devices is well known in the prior art, further description is hereby omitted. In FIG. 2, the controller 208 on the first peripheral device 202 acts as the master of the IDE/SATA channel 206. In this way, the host 202 can access the first peripheral device 204 using the IDE/SATA channel 206.

FIG. 3 is a block diagram of a second IDE bus architecture 300 having a first peripheral device 302 and a second peripheral device 304 according to the prior art. In the second IDE bus architecture 300 shown in FIG. 3, the first peripheral device 302 is electrically connected to a host 306 using a first port 308 of an IDE channel 310, and the second peripheral device 304 is electrically connected to the host 306 using a second port 312 of the IDE channel 310. The first peripheral device 302 is an optical storage device similar to that shown in FIG. 2 and includes the controller 208, the optical pick-up 210, the optical storage medium 212, and the buffer memory 214. The second peripheral device 304 is a flash card device and includes a controller 314, a flash card access device 316, and buffer memory 318. The controller 208 on the first peripheral device 302 acts as the master of the IDE channel 310 and the controller 314 on the second peripheral device 304 acts as the slave on the IDE channel 310. In this way, the host 306 can access the two peripheral devices 302, 304 using the IDE channel 310.

One disadvantage with the second IDE bus architecture 300 shown in FIG. 3 is that there is a large amount of redundancy between the first peripheral device 302 and the second peripheral device 304. Both peripheral devices 302, 304 include controllers 208, 314; buffer memory 214, 318; as well as other hardware (not shown) that could be shared between the two peripheral devices if they were implemented as a single product.

FIG. 4 is a block diagram of a third IDE bus architecture 400 having a first peripheral device 402 and a second peripheral device 404 implemented as a single product 406 according to the prior art. In the third IDE bus architecture 400 shown in FIG. 4, the product 406 includes the first peripheral device 402 being an optical storage device and including the optical pick-up 210 and the optical storage medium 212. The product 406 also includes the second peripheral device 404 being a flash card device and including the flash card access device 316. The product 406 further includes buffer memory 416 and a single controller 418. The controller 418 has a first interface connection 420 connected to a first port 410 on the IDE channel 414 and a second interface connection 422 connected to a second port 412 on an IDE channel 414. In this way, the product 406 shares the single controller 418, the buffer memory 416, and possibly other hardware between the two peripheral devices 402, 404. However, the third IDE bus architecture 400 uses both ports 410, 412 of the IDE channel 414, which does not allow for the addition of a third peripheral device on the IDE channel 414.

FIG. 5 is a block diagram of a fourth IDE bus architecture 500 having the first peripheral device 402 and the second peripheral device 404 implemented as a single product 506 according to the prior art. The difference between the third IDE bus architecture 400 and the fourth IDE bus architecture 500 is that the fourth IDE bus architecture 500 includes a controller 502 having a single interface connection 504. The single interface connection 504 physically occupies only one port 410 of the IDE channel 414. For example, the interface connection 504 only occupies one of either Port 0 or Port 1 shown in FIG. 1. However, the controller electrically acts as both the slave and the master of the IDE channel 414. This effectively means that although the product 506 is physically only connected to a single port 410, the host 408 can access both the first peripheral device 402 and the second peripheral device 404. One problem with the fourth IDE bus architecture 500 is that the implementation is limited to a maximum of only two peripheral devices because the IDE channel 414, and therefore the single port 410, is designed to provide access to a maximum of only two peripheral devices. In other words, the single port 410 of the IDE channel 414 can only provide access to a maximum of two devices and, for this reason, the product 506 can have a maximum of only two peripheral devices. Additionally, if a third peripheral device is connected to the second port 412, the host will lose access to either the first peripheral device 402 or the second peripheral device 404. The reason for this is that the IDE channel 414 only supports one master device and one slave device. The fact that the product 506 is physically only connected to one port 410 is not the only factor that determines whether the second port can be used or not. An important factor is that the IDE channel was designed to provide access to only two peripheral devices: a master and a slave. As the product 506 is electrically connected to the first port 410 as both the master and the slave, if a third peripheral device is connected to the second port 412, the third peripheral device must also be configured as either a master or a slave. The third peripheral will then conflict with either the first or the second peripheral device 402, 404. In this case, either the first or second peripheral device 402, 404 must be disabled when a third peripheral device is connected on the second port 412. As such, the fourth IDE bus architecture 500 is very inconvenient to the user.

### SUMMARY OF INVENTION

One objective of the claimed invention is therefore to provide an electronic system having a host being capable of accessing a plurality of peripheral devices on a single port of a predetermined interconnection means, to avoid limiting the number of peripheral devices accessible on the predetermined interconnection means.

According to the claimed invention, an electronic system is disclosed comprising a host; a controller electrically coupled to the host through a single port of a predetermined interconnection means, the single port being designed for providing the host access to N devices; and M peripheral devices electrically coupled to the controller. Wherein M is greater than N and the controller allows the host to access the peripheral devices using the single port.

Also according to the claimed invention, an electronic system is disclosed comprising a host; a controller electrically coupled to the host through a single port of a predetermined interconnection means, the single port being designed for providing the host access to N devices; and M peripheral devices electrically coupled to the controller, the peripheral devices including a first peripheral device and a second peripheral device. Wherein M is greater than N, the controller allows the host to access the peripheral devices using the single port, and the controller directly transfers data stored on the first peripheral to the second peripheral device without buffering the data in the host.

Also according to the claimed invention, a method is disclosed for accessing a plurality of peripheral devices from a host. The method comprises coupling a controller to the host though a single port of a predetermined interconnection means, the single port being designed for providing the host access to N devices; coupling M peripheral devices to the controller, wherein M is greater than N; and accessing the peripheral devices using the single port.

Also according to the claimed invention, a method is disclosed for accessing a plurality of peripheral devices from a host. The method comprises coupling a controller to the host though a single port of a predetermined interconnection means, the single port being designed for providing the host access to N devices; coupling M peripheral devices to the controller, wherein M is greater than N and the M peripheral devices include a first peripheral device and a second peripheral device; accessing the peripheral devices using the single port; and directly transferring data stored on the first peripheral device to the second peripheral device without buffering the data in the host.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a typical IDE bus cable.

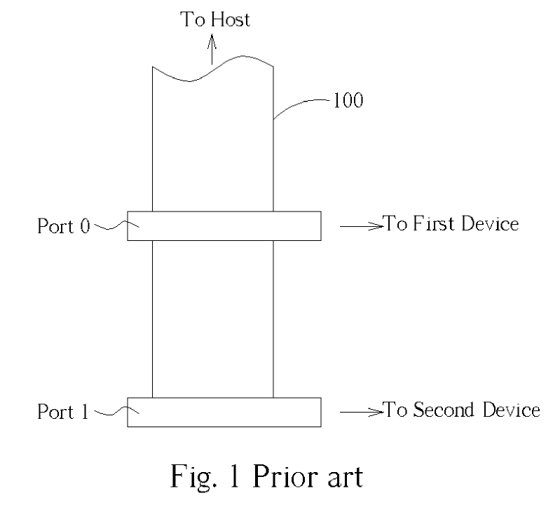

FIG. 2 is a block diagram of a first IDE/SATA architecture having a single peripheral device according to the prior art.

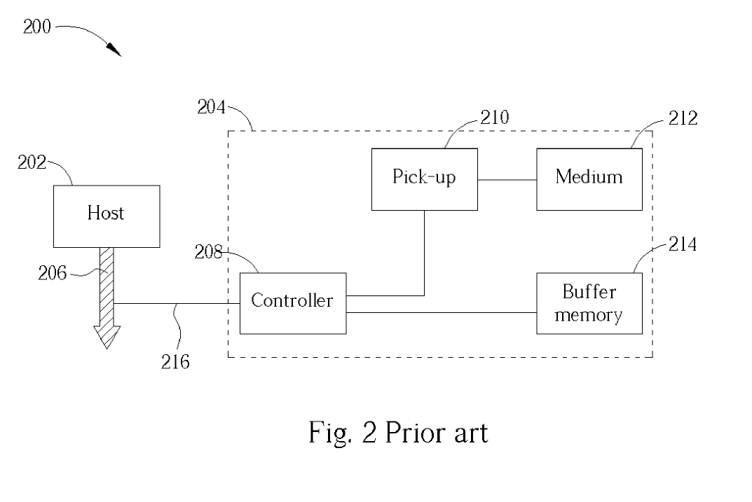

FIG. 3 is a block diagram of a second IDE bus architecture having a first peripheral device and a second peripheral device according to the prior art.

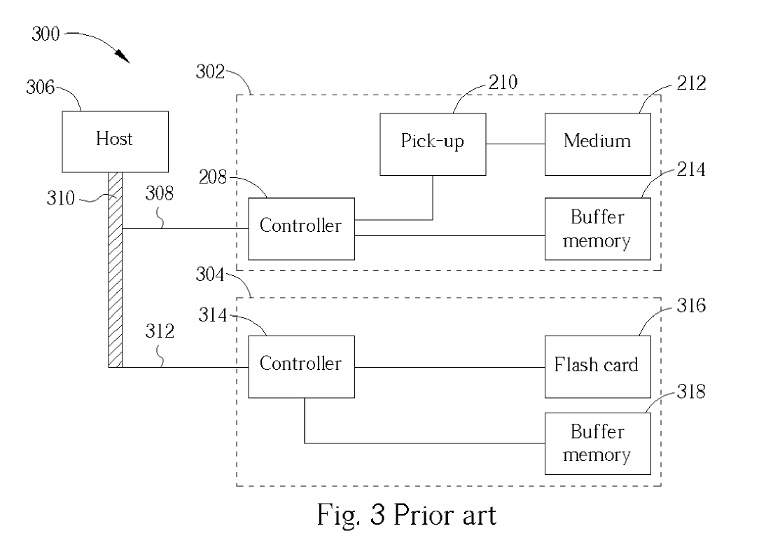

FIG. 4 is a block diagram of a third IDE bus architecture having a first peripheral device and a second peripheral device implemented as one product according to the prior art.

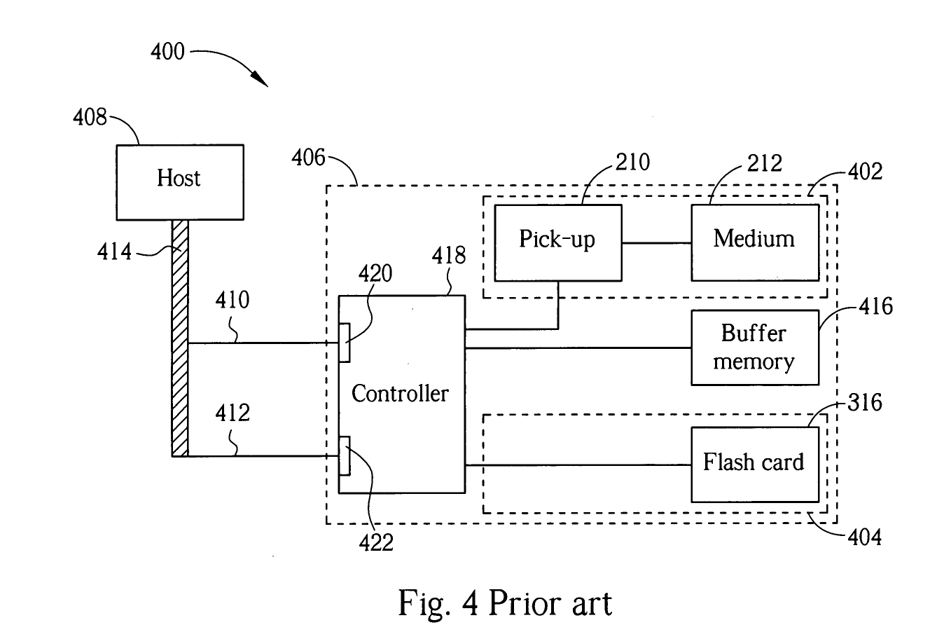

FIG. 5 is a block diagram of a fourth IDE bus architecture having the first peripheral device and the second peripheral device implemented as one product according to the prior art.

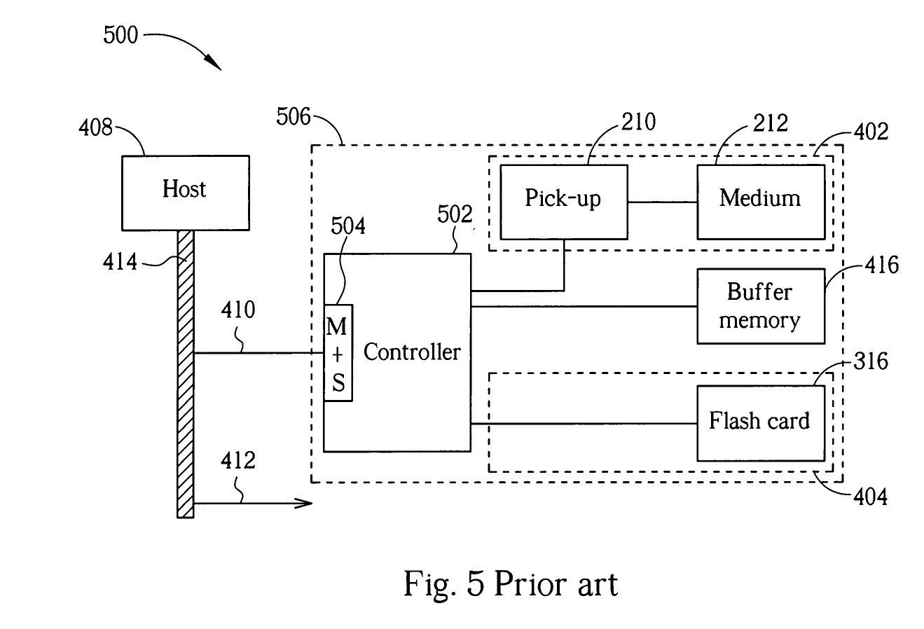

FIG. 6 is an electronic system having a host capable of accessing a plurality of peripheral devices on a single port of an IDE bus or a SATA interface according to the present invention.

FIG. 7 is a more detailed block diagram of the controller of FIG. 6.

FIG. 8 is a typical ATAPI command packet corresponding to the READ(10) command.

FIG. 9 is a typical IDE task file.

FIG. 10 is a diagram showing the interaction between driver software running on the host and firmware software running on the controller of FIG. 6.

FIG. 11 is a flowchart describing a general method for accessing a plurality of peripheral devices on a single port of a predetermined bus from a host according to the present invention.

### DETAILED DESCRIPTION

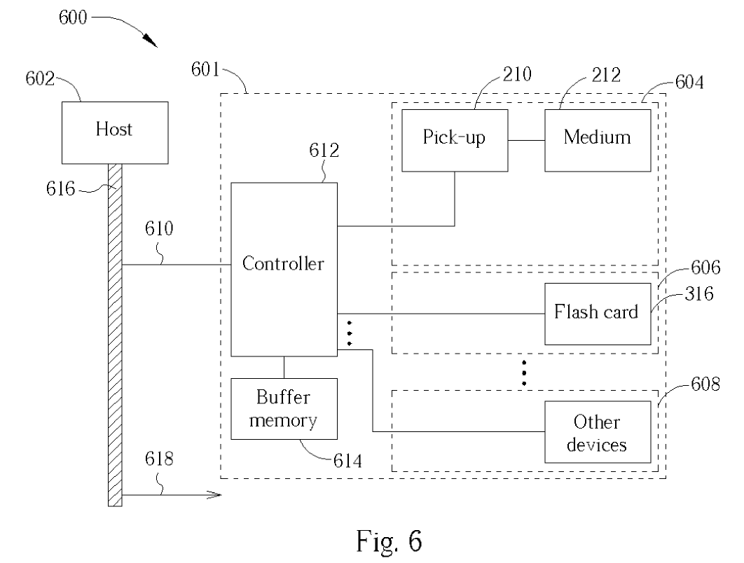

FIG. 6 is an electronic system 600 having a host 602 capable of accessing a plurality of peripheral devices 604, 606, 608 on a single port 610 of an IDE bus or a SATA interface according to the present invention. The electronic system 600 includes the host 602, a controller 612, buffer memory 614, and at least a first peripheral device 604 and a second peripheral device 606. The first peripheral device 604 is an optical storage device and includes the optical pick-up 210, and the optical medium 212. The second peripheral device 606 is a flash card device and includes the flash card access device 316. Additionally, more peripheral devices 608 having other functions can be included. Each of the peripheral devices 604, 606, 608 is connected to the controller 612. The controller 612 is also electrically connected to the single port 610 of the IDE/SATA channel 616 and allows the host 602 to access each of the peripheral devices 604, 606, 608 through the single port 610. By modifying control codes and/or reserved vender-specific bits in ATA Packet Interface (ATAPI) packets or registers in the IDE Task File that are sent between the host 602 and the controller 612, the host 602 is able to specify a target peripheral device. Using this structure, the three peripheral devices 604, 606, 608 can be implemented as a single product 601 and share the buffer memory 614 and other hardware (not shown). Additionally, the product 601 can have more than two peripheral devices and, because the controller 612 is only connected to a single port 610 of the IDE channel 616, other peripheral devices can still be attached to a second port 618 of the IDE channel 616 without loosing any of the functionally of the product 601 connected on the first port 610.

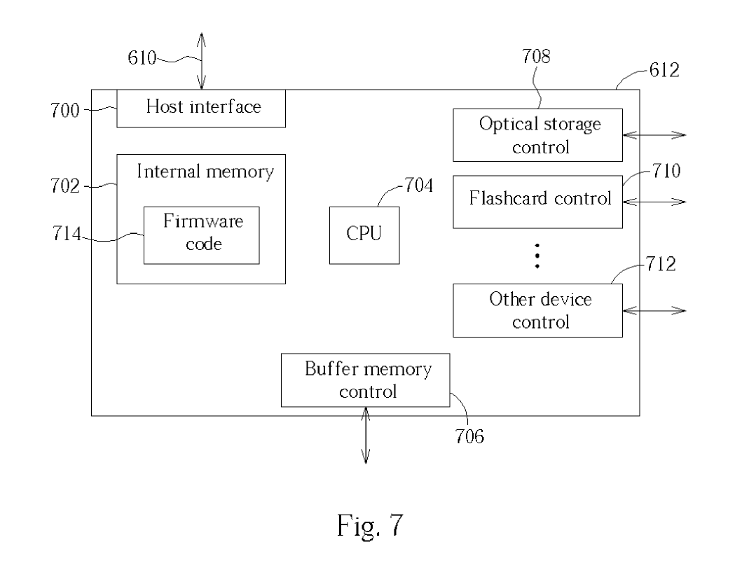

FIG. 7 is a more detailed block diagram of the controller 612 of FIG. 6. The controller 612 includes a host interface 700, internal memory 702, a central processing unit (CPU) 704, a buffer memory control unit 706, an optical storage control unit 708, a flash card control unit 710, and other device control unit(s) 712.

The host interface 700 electrically connects the controller 612 to the single port 610. Depending on configuration options, the host interface 700 can connect to the IDE/SATA channel 616 as either a master or as a slave. The present invention is not limited to the selection of master or slave but rather that host interface 700 is electrically connected to one port 610 of the IDE channel 616 as only master or as only slave. In this way, the other port (i.e. the other master/slave setting) is free for use by another peripheral device connected to the IDE channel 616.

The internal memory 702 is used by the CPU as a temporary storage area and also includes program instructions corresponding to firmware code 714, which are executed by the CPU 704. It should be noted that the firmware code 714 could also be stored in external non-volatile memories (not shown) on the controller 612. The firmware code 714 contains instructions that allow the CPU to read control codes and/or reserved vendor-specific bits in the ATAPI packets or registers in the IDE Task File that are sent between the host 602 and the controller 612. These control codes, reserved vendor-specific bits, and registers in the IDE Task File are referred to as a target device tag, which specifies a target peripheral device. The target peripheral device is one of the peripheral devices 604, 606, 608 connected to the controller 612. The CPU 704 accepts ATAPI commands from the host interface 700 and executes the commands according to the target device tag using the appropriate control unit. More specifically, if the target device tag specifies the optical storage device 604, the CPU 704 executes the ATAPI command using the optical storage control unit 708; if the target device tag specifies the flash card device 606, the CPU 704 executes the ATAPI command using the flash card control unit 710; and if the target device tag specifies another device 608, the CPU 704 executes the ATAPI command using the control unit for that device 712.

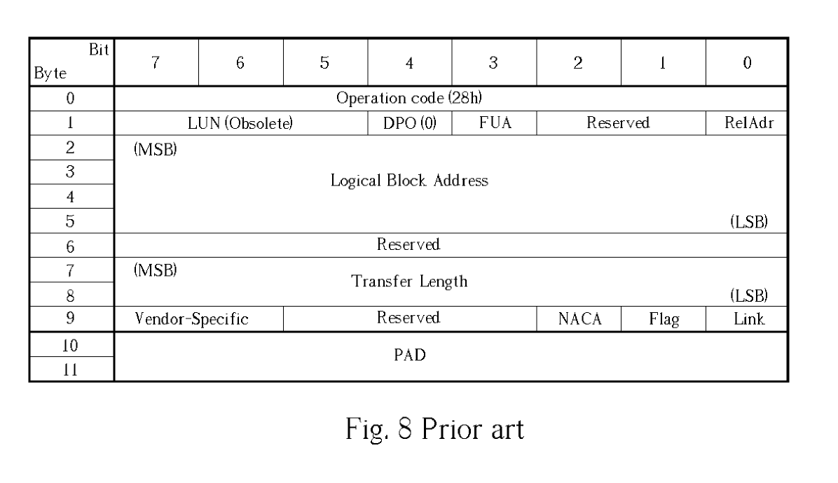

FIG. 8 is a typical ATAPI command packet corresponding to the READ(10) command. As an example of specifying the target device tag by modifying control codes and/or reserved vendor-specific bits in the ATAPI packet, the Operation Code field can be changed from a value of 28h to a value of 68h. In this embodiment, the value of 68h specifies a target device being the second peripheral device 606 (the flash card device) while the original value of 28h specifies a target device being the first peripheral device 604 (the optical storage device). Other unused Operation Code values can be used to specify the target device tag. Alternatively, the highest 3 bits in byte 1, the highest 2 bits in byte 9, and bytes 6, 10, and 11 are unused bits in the ATAPI command packet and can also be used to specify the target device tag.

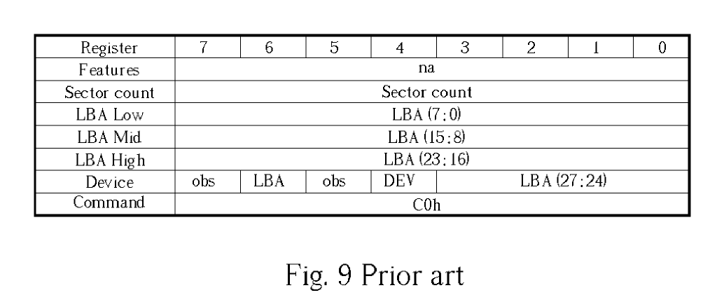

FIG. 9 is a typical IDE task file. Similar to the unused bits in the ATAPI command packet shown in FIG. 8, the Device register in the IDE task file has some obsolete bits (obs) that can also be used to specify the target device tag. It should be noted that the present invention is not limited to using one field of the IDE task file shown in FIG. 9 or the ATAPI command packet shown in FIG. 8 to specify the device tag. A plurality of fields of in one or both of the ATAPI command packet or the IDE task file can also be used, according to design requirements such as the number of peripheral devices connected to the controller 612.

There are several advantages of the present invention corresponding to the electronic system 600 shown in FIG. 6 and the controller 612 shown in FIG. 7. Firstly, all the peripheral devices 604, 606, 608 connected to the controller 612 share both the controller 612 and the buffer memory 614. Because the controller 612 according to the present invention is not limited in the number of attached peripheral devices, this amounts to substantial savings in the number of controllers and amount of buffer memory needed in the electronic system 600. Additionally, other hardware items (not shown) can similarly be shared among the peripheral devices connected to the controller 612 such as power supplies, clock/timing circuits, cache circuits, indicators, etc. Another advantage of the present invention is that by using direct memory access (DMA), data can be directly transferred from one peripheral device that is connected to the controller 612 to another peripheral device that is also connected to the controller 612. The data does not need to be sent across the IDE bus or SATA interface to be temporarily buffered in the host 602. Again, because the controller 612 according to the present invention is not limited in the number of attached peripheral devices, this greatly reduces unnecessary data transfer on the IDE bus or SATA interface and increases the overall efficiency of the electronic system 600.

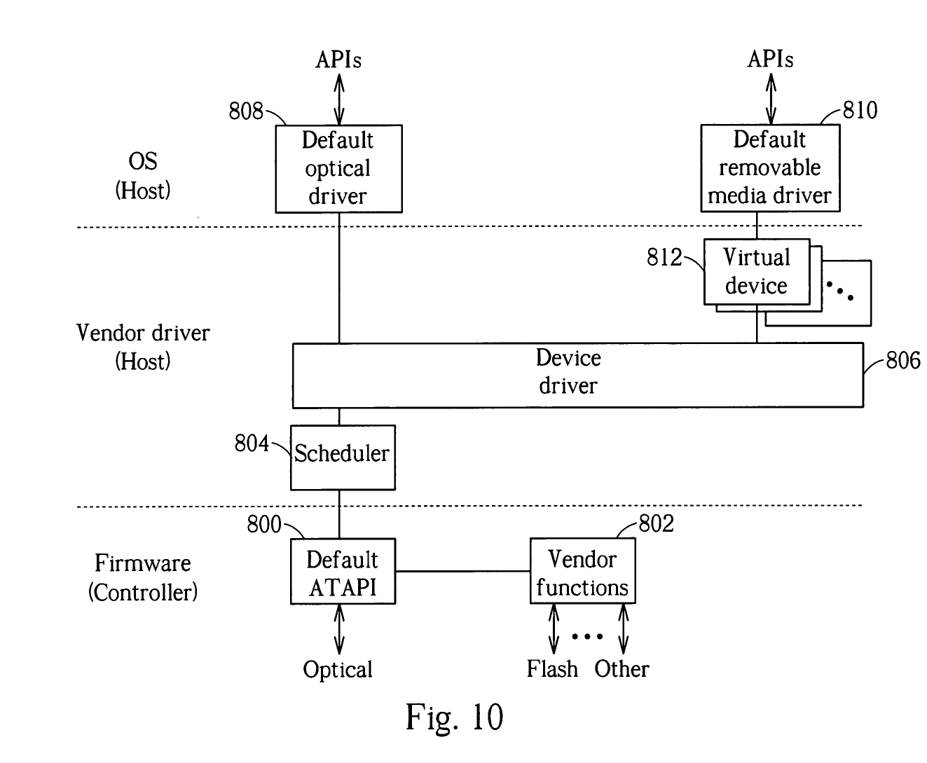

FIG. 10 is a diagram showing the interaction between driver software running on the host and firmware software running on the controller of FIG. 6. The host 602 runs an operating system (OS) in addition to a vendor driver corresponding to the controller 612. The controller 612 has firmware code 714, which includes both a default ATAPI driver code 800 and code specifying vendor specific functions 802. The vendor driver running on the host 612 includes an (optional) scheduler 804 and a device driver 806. The OS includes a default optical device driver 808 and default removable media driver 810.

In one embodiment of the present invention, the optical storage device 604 is controlled by the default optical device driver 808 using unmodified ATAPI commands. On boot-up or during initialization, the device driver 806 determines which other peripheral devices are connected to the controller 612 by reading a product model number from the controller 612. The device driver 806 then creates a plurality of virtual devices 812 corresponding to the other peripheral devices 606, 608 that are connected to the controller 612. The default optical device driver 808 provides a set of Application Program Interfaces (APIs) to user programs that need to access the optical storage device 604, and the default removable media driver 810 provides a set of APIs to the user space to allow user programs to access the other peripheral devices 606, 608 connected to the controller 612. The device driver 806 then modifies the target device tag for ATAPI packets that are sent to one of the other peripheral devices 606, 608 connected to the controller 612 other than the default device, which in this embodiment is the optical storage device 604. Likewise, ATAPI packets that are received by the default optical device driver 808 from the controller 612 having modified target device tags are passed to the device driver 806. In the controller 612, unmodified ATAPI packets are executed using the optical storage control unit 708 while modified ATAPI packets are passed to the appropriate control unit by the vendor specific functions code 802. Additionally, because some operations, such as high speed write operations to an optical medium, are very time critical, the (optional) scheduler 804 can be used to ensure that time critical ATAPI packets are passed to the controller 612 before non time critical ATAPI packets based on a priority ranking. The priority ranking can be a dynamic ranking that varies according to operations, such as write operations, or speed settings of the peripheral devices. For example, ATAPI packets being sent to a 12× speed digital versatile disc (DVD) writer are much more time critical than packets being sent to a flash card device or even a 2× speed DVD writer. In this way, peripheral devices having different timing requirements can be connected to the same controller 612 and reliably share the single port 610.

Because the optical storage device (the first peripheral device 604) is configured as the default device and is controlled by the default optical device driver 808 using unmodified ATAPI commands, it is an advantage of the present invention that even if the host 612 does not include a suitable vendor specific device driver 806, the optical storage device 604 can still be accessed by the host 602. It should also be noted that although in the preferred embodiment of the present invention the default device is the optical storage device 604, in other embodiments, other peripheral devices can also be configured as the default. The setting could also be a user selectable setting that is stored in the controller 612.

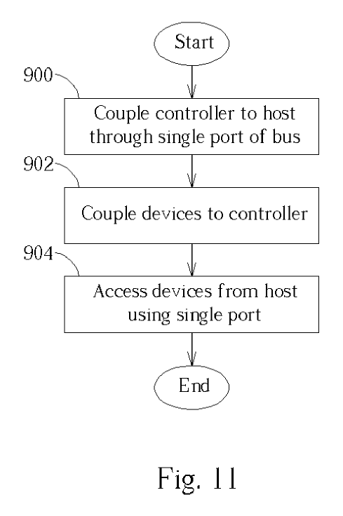

Although the description of the present invention has focused on the IDE bus and the SATA interface, the present invention is not limited to these interconnection types. FIG. 11 is a flowchart describing a general method for accessing a plurality of peripheral devices on a single port of a predetermined interconnection means from a host according to the present invention. The flowchart contains the following steps:

Step 900: Couple a controller to the host through the single port of the predetermined interconnection means. The interconnection means can be an IDE bus or a SATA interface or another interconnection means supporting only a limited number of attached devices, the single port of the predetermined interconnection means being originally designed for providing the host access to a maximum of only N devices.

Step 902: Couple a plurality of M peripheral devices to the controller, wherein the number M is greater than the number N.

Step 904: Access the peripheral devices from the host using the single port of the predetermined interconnection means. By modifying a target device tag in packets that are sent between the host and the controller, a target peripheral device can be specified. Using this method, the M peripheral devices can share buffer memory and other hardware in or connected to the controller. Additionally, because the controller is only connected to a single port of the predetermined interconnection means, other peripheral devices can be attached to other ports without loosing any of the functionally of the M peripheral devices connected to the controller.

It is an advantage of the present invention that an additional step can also be added after Step 904, the additional step being: Directly transferring data from one peripheral device that is connected to the controller to another peripheral device that is also connected to the controller. Direct memory access (DMA) can be used to perform this transfer and will significantly increase the efficiency of an electronic system implementing the method according to the present invention.

Those skilled in the art will readily observe that numerous modifications and alterations of the device may be made while retaining the teachings of the invention. Accordingly, the above disclosure should be construed as limited only by the metes and bounds of the appended claims.

1. An electronic system comprising:
a host;
a controller electrically coupled to the host through a single port of a predetermined interconnection means, the single port being designed for providing the host access to N devices; and
M peripheral devices electrically coupled to the controller;
wherein M is greater than N and the controller allows the host to access the peripheral devices using the single port.

2. The electronic system of claim 1, wherein the predetermined interconnection means is an Integrated Drive Electronics (IDE) bus or a Serial AT Attachment (SATA) interface.

3. The electronic system of claim 1, wherein the host modifies predetermined fields in packets or registers in an IDE task file that are sent to the controller through the single port to specify a target peripheral device.

4. The electronic system of claim 3, wherein the predetermined fields are control codes or reserved vendor-specific bits in ATA Packet Interface (ATAPI) packets that are sent to the controller through the single port to specify the target peripheral device.

5. The electronic system of claim 1, wherein the M peripheral devices electrically coupled to the controller at least comprise an optical storage device and a non-volatile storage device.

6. The electronic system of claim 5, wherein the non-volatile storage device is a flash card access device or a hard-disk drive.

7. The electronic system of claim 1, wherein the host schedules packets sent to the M peripheral devices according to a priority ranking.

8. The electronic system of claim 7, wherein the priority ranking is a dynamic ranking that varies according to operations or speed settings of the peripheral devices.

9. The electronic system of claim 1, wherein the M peripheral devices include a first peripheral device and a second peripheral device, and the controller directly transfers data stored on the first peripheral device to the second peripheral device without buffering the data in the host.

10. The electronic system of claim 1, wherein the host determines which peripheral devices are coupled to the controller and builds a set of virtual drives in an operating system (OS) of the host corresponding the peripheral devices coupled to the controller.

11. An electronic system comprising:
a host;
a controller electrically coupled to the host through a single port of a predetermined interconnection means, the single port being designed for providing the host access to N devices; and
M peripheral devices electrically coupled to the controller, the peripheral devices including a first peripheral device and a second peripheral device;
wherein M is greater than N, the controller allows the host to access the peripheral devices using the single port, and the controller directly transfers data stored on the first peripheral to the second peripheral device without buffering the data in the host.

12. The electronic system of claim 11, wherein the predetermined interconnection means is an Integrated Drive Electronics (IDE) bus or a Serial AT Attachment (SATA) interface.

13. The electronic system of claim 11, wherein the host modifies predetermined fields in packets or registers in an IDE task file that are sent to the controller through the single port to specify a target peripheral device.

14. The electronic system of claim 13, wherein the predetermined fields are control codes or reserved vendor-specific bits in ATA Packet Interface (ATAPI) packets that are sent to the controller through the single port to specify the target peripheral device.

15. The electronic system of claim 11, wherein the M peripheral devices electrically coupled to the controller at least comprise an optical storage device and a non-volatile storage device.

16. The electronic system of claim 15, wherein the non-volatile storage device is a flash card access device or a hard-disk drive.

17. The electronic system of claim 11, wherein the host schedules packets sent to the M peripheral devices according to a priority ranking.

18. The electronic system of claim 17, wherein the priority ranking is a dynamic ranking that varies according to operations or speed settings of the peripheral devices.

19. The electronic system of claim 11, wherein the host determines which peripheral devices are coupled to the controller and builds a set of virtual drives in an operating system (OS) of the host corresponding the peripheral devices coupled to the controller.

20. A method for accessing a plurality of peripheral devices from a host, the method comprising:
coupling a controller to the host though a single port of a predetermined interconnection means, the single port being designed for providing the host access to N devices;
coupling M peripheral devices to the controller, wherein M is greater than N; and
accessing the peripheral devices using the single port.

21. The method of claim 20, wherein the predetermined interconnection means is an Integrated Drive Electronics (IDE) bus or a Serial AT Attachment (SATA) interface.

22. The method of claim 20, further comprising:
modifying predetermined fields in packets or registers in an IDE task file being sent to the controller through the single port; and
determining a target peripheral device according to the predetermined fields or the registers.

23. The method of claim 22, wherein the predetermined fields are control codes or reserved vendor-specific bits in ATA Packet Interface (ATAPI) packets that are sent to the controller through the single port to specify the target peripheral device.

24. The method of claim 20, wherein the M peripheral devices coupled to the controller at least comprise an optical storage device and a non-volatile storage device.

25. The method of claim 24, wherein the non-volatile storage device is a flash card access device or a hard-disk drive.

26. The method of claim 20, further comprising scheduling packets sent to the M peripheral devices according to a priority ranking.

27. The method of claim 26, further comprising
dynamically varying the priority ranking according to operations or speed settings of the peripheral devices.

28. The method of claim 20, wherein the M peripheral devices include a first peripheral device and a second peripheral device, the method further comprising:
directly transferring data stored on the first peripheral device to the second peripheral device without buffering the data in the host.

29. The method of claim 20, further comprising:
determining which peripheral devices are coupled the controller; and
building a set of virtual drives in an operating system (OS) of the host corresponding the peripheral devices coupled to the controller.

30. A method for accessing a plurality of peripheral devices from a host, the method comprising:
coupling a controller to the host though a single port of a predetermined interconnection means, the single port being designed for providing the host access to N devices;
coupling M peripheral devices to the controller, wherein M is greater than N and the M peripheral devices include a first peripheral device and a second peripheral device;
accessing the peripheral devices using the single port; and
directly transferring data stored on the first peripheral device to the second peripheral device without buffering the data in the host.

31. The method of claim 30, wherein the predetermined interconnection means is an Integrated Drive Electronics (IDE) bus or a Serial AT Attachment (SATA) interface.

32. The method of claim 30, further comprising:
modifying predetermined fields in packets or registers in an IDE task file being sent to the controller through the single port; and
determining the target peripheral device according to the predetermined fields or the registers.

33. The method of claim 32, wherein the predetermined fields are control codes or reserved vendor-specific bits in ATA Packet Interface (ATAPI) packets that are sent to the controller through the single port to specify the target peripheral device.

34. The method of claim 30, wherein the M peripheral devices coupled to the controller at least comprise an optical storage device and a non-volatile storage device.

35. The method of claim 34, wherein the non-volatile storage device is a flash card access device or a hard-disk drive.

36. The method of claim 25, further comprising scheduling packets sent to the M peripheral devices according to a priority ranking.

37. The method of claim 36, further comprising dynamically varying the priority ranking according to operations or speed settings of the peripheral devices.

38. The method of claim 30, further comprising:
determining which peripheral devices are coupled the controller; and
building a set of virtual drives in an operating system (OS) of the host corresponding the peripheral devices coupled to the controller.

39. An electronic system comprising:
a host;
a controller electrically coupled to the host to communicate data through a single port of a predetermined interconnection means, the single port being designed for providing the host access to N devices;
M peripheral devices electrically coupled to the controller, wherein M is greater than N and the controller allows the host to access the peripheral devices using the single port; and
a memory for storing the data, wherein the memory is shared by the extra (M-N) devices.

40. The electronic system of claim 39, wherein the predetermined interconnection means is an Integrated Drive Electronics (IDE) bus or a Serial AT Attachment (SATA) interface.

41. The electronic system of claim 39, wherein the host modifies predetermined fields in packets or registers in an IDE task file that are sent to the controller through the single port to specify a target peripheral device.

42. The electronic system of claim 41, wherein the predetermined fields are control codes or reserved vendor-specific bits in ATA Packet Interface (ATAPI) packets that are sent to the controller through the single port to specify the target peripheral device.

43. The electronic system of claim 39, wherein the M peripheral devices electrically coupled to the controller at least comprise an optical storage device and a non-volatile storage device.

44. The electronic system of claim 43, wherein the non-volatile storage device is a flash card access device or a hard-disk drive.

45. The electronic system of claim 39, wherein the host schedules packets sent to the M peripheral devices according to a priority ranking.

46. The electronic system of claim 45, wherein the priority ranking is a dynamic ranking that varies according to operations or speed settings of the peripheral devices.

47. The electronic system of claim 39, wherein the M peripheral devices include a first peripheral device and a second peripheral device, and the controller directly transfers data stored on the first peripheral device to the second peripheral device without buffering the data in the host.

48. The electronic system of claim 39, wherein the host determines which peripheral devices are coupled to the controller and builds a set of virtual drives in an operating system (OS) of the host corresponding the peripheral devices coupled to the controller.
